(19) United States
(12) Patent Application Publication
(10) Pub. No.: US 2015/0033294 A1
(43) Pub. Date: Jan. 29, 2015

(54) NETWORK MANAGEMENT SYSTEM ARCHITECTURE OF A TELECOMMUNICATIONS NETWORK

(71) Applicant: Xtera Communications, Inc., Allen, TX (US)

(72) Inventor: HERVE FEVRIER, Miami, FL (US)

(21) Appl. No.: 14/341,323

(22) Filed: Jul. 25, 2014

Related U.S. Application Data
(60) Provisional application No. 61/858,739, filed on Jul. 26, 2013.

(51) Int. Cl. H04L 12/26; H04L 12/24; H04L 29/06

(52) U.S. Cl. CPC H04L 43/0876; H04L 63/08; H04L 41/28
USPC 726/4; 709/224

(57) ABSTRACT

Network management of a telecommunications network. An external system, such as a cloud computing environment, receives network element data from the network management system of the telecommunications network over a channel that may be encrypted. The network element data are parameter samples that the network management system has collected from one or more network elements within the telecommunications network. The external system then processes at least some of the received network element data. The external system might also receive network element data from other network management systems of other telecommunications networks also. Furthermore, the external system might also have external information not received from the network management system. The external system may perform processing on all of this information in conjunction with the received network element data in order to perform sophisticated analytics.

### CROSS-REFERENCE TO RELATED APPLICATIONS

This application claims the benefit under 35 U.S.C. 119(e) of U.S. Provisional Application No. 61/858,739 filed Jul. 26, 2013, which provisional patent application is herein incorporated by reference in its entirety.

### BACKGROUND

Telecommunications networks are networks that allow communication of information over a distance, and often a great distance, via the use of electromagnetic signals. Telecommunication networks based on propagation of electronic signals through electrical conductors have been available since the time of the telegraph. Telecommunication networks based on propagation of optical signals has been a more recent development. Regardless, the invention and improvement in the ability of human beings to communicate over distances, often great distances, has presented a paradigm shift in human interaction, greatly benefiting human civilization.

Conventional telecommunications technology represents the culmination of decades, and in some cases, centuries of human thought and collaboration. At present, sophisticated optical communications networks are capable of transmitting tens of trillions of bits of information per second over a single optical fiber spanning many kilometers. Optical networks generally exceed the bandwidth capabilities of copper networks. Accordingly, optical networks are part of the wireline telecommunication networks and often provide optical backbones at the core of the telecommunication networks.

Typically, these core optical networks use Dense Wavelength Division Multiplexed (DWDM) optical systems in which optical channels (referred to as “DWDM channels”) are allocated by their optical frequency. These optical systems employ equipment in different sites of the network, each site composed of network elements that constitute the physical layer of the network. Conventional optical networks are often meshed networks with protection and restoration capabilities, and in which there are Reconfigurable Optical Add/Drop Multiplexers (ROADMs) at the nodes of the mesh. (Reconfigurable Optical Add/Drop Multiplexers).

Optical networks are often configured and provisioned through a “network management system”, which allows one or more people in the network operations center to change the configuration of the network, to monitor the activity and performance of this network, and so forth.

FIG. 1 illustrates a prior art network management environment 100, which includes various network elements (conventionally racks of electronics) found at different sites. The different sites that include one or more of such network elements are labelled 101(1) through 101(N) (hereinafter collectively referred to as network element sites 101), where “N” is a whole number representing the number of such sites. Although each network element site 101 may contain multiple network elements, for simplicity, only two network elements A and B are illustrated. The network elements of the various network element sites 101 connect to a server 102 over a Data Communications Network (DCN) 105. The server 102 runs thereon software referred to herein as a network management system 103. The network elements within the various network element sites 101 support a telecommunications network 106.

This data communications network 105 is a sort of private telecommunications network which conventionally is closed and private (without any connection to outside networks, and particular without connection to the Internet) so as to prevent intrusion and possible disruptions to service in the telecommunication system served by the network elements of the network element sites 101.

The data communications network 105 is conventionally very often an Internet Protocol (IP) based network, where each network element (and the server that runs the network management system 102) has a different IP address. The network management system 103 typically has access to storage 104 of a large storage capacity, which is used to store large volumes of data (perhaps in a database) corresponding to the optical network. For instance, the network management system might cause performance monitoring data to be stored within the storage 104.

As an example, suppose there is a 10 gigabit per second connection between network element A in network element site 101(1) and network element B in network element site 101(2). Accordingly, the hardware modules in each network element A and B is present to enable this communication. Furthermore, the design of network elements A and B is such that it is possible to monitor quality of the transmission and to monitor a whole set of parameter settings of the hardware modules. These measurements are stored in the storage 104 (which again could be organized in a database).

As an example, typically the structure of the measurements is such that each parameter that is monitored will be measured on a periodic basis on given intervals (e.g., a 15 minute interval). The measurements are stored in, for example, the database. In one example, there might be three items of data for the parameter that are stored: the maximum value of the parameter in the particular interval, the minimum value of the parameter in the particular interval, and an instantaneous value for this parameter (for example at the end the 15 minute interval).

This is an example of one parameter of one hardware module for one network element. Each network element is composed of several different hardware modules. One hardware module can be the controller of the network element. Furthermore, there may be other hardware modules which allow to configure the telecommunications network, change the configuration of the telecommunications network, provide optical interfaces to this telecommunications network in order to the user to transmit an exchange data through the optical network, and so forth. So, in each network element, there may be several hardware modules; and for each hardware module there may be several parameters which are monitored. This means that with this periodicity being 15 minutes, the performance monitoring data constitutes a huge amount (on the order of tens of megabytes daily) of data being stored in the database.

This network management system 103 and associated storage 104 can also have an architecture with a redundancy in order to be extremely reliable. Furthermore, as previously described, the network management system is used by the network operations center people to configure the network, monitor the network, and detect faults and correct these faults.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

At least one embodiment described herein relates to network management of a telecommunications network. An external system, such as a cloud computing environment, receives network element data from the network management system of the telecommunications network. For instance, such network element data may be received over an encrypted channel. The network element data are parameter samples that the network management system has collected from one or more network elements within the telecommunications network. The external system then processes at least some of the received network element data.

The external system might also receive network element data from other network management systems of other telecommunications networks. Furthermore, the external system might also have external information not received from the network management system, but perhaps from other sources. For instance, such external information could include manufacture data (e.g., collected at the time of manufacturing of the different hardware modules), weather data (e.g., corresponding to the weather where the different sites are located), position data (geographic positioning of the different elements of the network), and so forth. The external system may perform processing on all of this information in conjunction with the received network element data in order to perform sophisticated analytics. For instance, the external system might perform trending or predictive analysis regarding parameters sampled in the network element data. The external system might allow authorized users that are not connected to the network management system to still obtain data and results of the analysis after proper authentication to the external system.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 schematically illustrates a prior art network management environment, which includes various network element sites connected to each other and to a server that runs a network management system over a data communications network;

FIG. 2 abstractly illustrates a computing system in which some embodiments described herein may be employed;

FIG. 3 illustrates a network management environment in accordance with at least one embodiment described herein, which includes the network management system providing network element data, such as performance monitoring data, to an external system, which external system might also receive network element data from other telecommunications networks and have access to external information, and report results of processing to various users;

FIG. 4 illustrates a flowchart of a method for processing network management data in an external system that is outside of a network management system; and

FIG. 5 illustrates a flowchart of a method for providing such resulting information to the authorized users.

### DETAILED DESCRIPTION

At least one embodiment described herein relates to network management of a telecommunications network. An external system, such as a cloud computing environment, receives network element data from the network management system of the telecommunications network. For instance, such network element data may be received over an encrypted channel. The network element data are parameter samples that the network management system has collected from one or more network elements within the telecommunications network. The external system then processes at least some of the received network element data.

The external system might also receive network element data from other network management systems of other telecommunications networks. Furthermore, the external system might also have external information not received from the network management system. For instance, such external information could include manufacture data (e.g., collected at the time of manufacturing of the different hardware modules), weather data (e.g., corresponding to the weather where the different sites are located), position data (geographic positioning of the different elements of the network), and so forth. The external system may perform processing on all of this information in conjunction with the received network element data in order to perform sophisticated analytics. For instance, the external system might perform trending or predictive analysis regarding parameters sampled in the network element data. The external system might allow authorized users that are not connected to the network management system to still obtain data and results of the analysis after proper authentication to the external system.

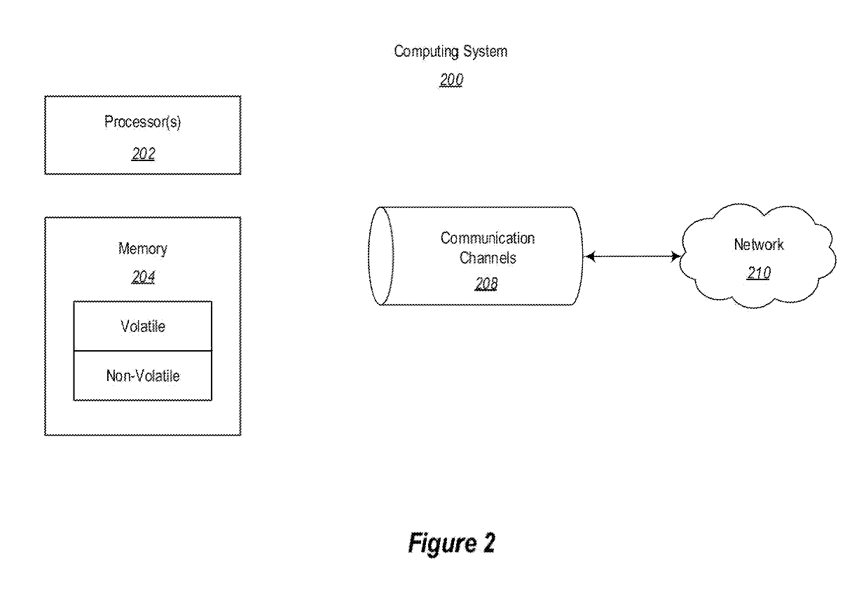

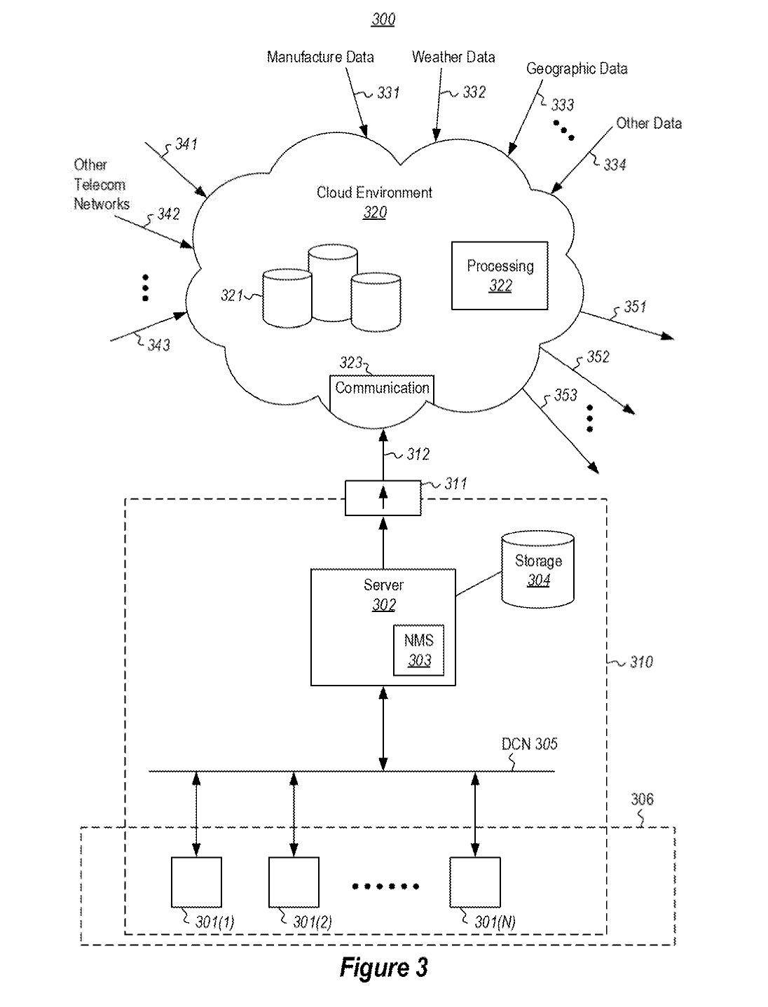

One or more aspects of one or more embodiments described herein may be implemented by use of a computing system. Accordingly, some introductory discussion of a computing system will first be described with respect to FIG. 2. Then, the network management environment architecture and operation will be described thereafter with respect to FIGS. 3 through 5.

Although the subject matter will be described in language specific to structural features and/or methodological acts, it is to be understood that the subject matter defined in the appended claims is not necessarily limited to the described features or acts described herein, or the order of the acts described herein. Rather, the described features and acts are disclosed as example forms of implementing the claims.

Computing systems are now increasingly taking a wide variety of forms. Computing systems may, for example, be handheld devices (such as smartphones or tablets), appliances, wearables (such as glasses), laptop computers, desktop computers, mainframes, distributed computing systems, datacenters or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the one or more processors. A computing system may be distributed over a network environment and may include multiple constituent computing systems.

As illustrated in FIG. 2, in its most basic configuration, a computing system 200 typically includes at least one processing unit 202 (i.e., processor) and memory 204. The memory 204 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

As used herein, the term “executable module” or “executable component” can refer to software objects, routines, or methods that may be executed on the computing system. The different components, modules, engines, and services described herein may be implemented as objects, routines, methods, functions, or the like, that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory 204 of the computing system 200. Computing system 200 may also contain communication channels 208 that allow the computing system 200 to communicate with other computing systems over, for example, network 210.

Embodiments described herein may comprise or utilize a special-purpose or general-purpose computing system that includes computer hardware, such as, for example, one or more processors and system memory, as discussed in greater detail below. The system memory may be included within the overall memory 204. The system memory may also be referred to as “main memory”, and includes memory locations that are addressable by the at least one processing unit 202 over a memory bus in which case the address location is asserted on the memory bus itself. System memory has been traditional volatile, but the principles described herein also apply in circumstances in which the system memory is partially, or even fully, non-volatile.

Embodiments within the scope of the present invention also include physical and other computer-readable media for carrying or storing computer-executable instructions and/or data structures. Such computer-readable media can be any available media that can be accessed by a general-purpose or special-purpose computing system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer-readable storage media and transmission media.

Computer-readable storage media are physical hardware storage media that store computer-executable instructions and/or data structures. Physical hardware storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computing system to implement the disclosed functionality.

Transmission media can include a network and/or data links which can be used to carry program code in the form of computer-executable instructions or data structures, and which can be accessed by a general-purpose or special-purpose computing system. A “network” is defined as one or more data links that enable the transport of electronic data between computer systems and/or modules and/or other electronic devices. When information is transferred or provided over a network or another communications connection (either hardwired, wireless, optical or a combination thereof) to a computing system, the computing system may view the connection as transmission media. Combinations of the above should also be included within the scope of computer-readable media.

Further, upon reaching various computing system components, program code in the form of computer-executable instructions or data structures can be transferred automatically from transmission media to computer-readable storage media (or vice versa). For example, computer-executable instructions or data structures received over a network or data link can be buffered in RAM within a network interface module (e.g., a “NIC”), and then eventually transferred to computing system RAM and/or to less volatile computer-readable storage media at a computing system. Thus, it should be understood that computer-readable storage media can be included in computing system components that also (or even primarily) utilize transmission media.

Computer-executable instructions comprise, for example, instructions and data which, when executed at one or more processors, cause a general-purpose computing system, special-purpose computing system, or special-purpose processing device to perform a certain function or group of functions. Computer-executable instructions may be, for example, binaries, intermediate format instructions such as assembly language, or even source code.

Those skilled in the art will appreciate that the principles described herein may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, datacenters, mobile telephones, PDAs, tablets, pagers, routers, switches, digital scanners, wearables, and the like. The invention may also be practiced in distributed system environments where local and remote computing systems, which are linked (either by hardwired data links, wireless data links, optical data links or by a combination thereof) through a network, both perform tasks. As such, in a distributed system environment, a computing system may include a plurality of constituent computing systems. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services).

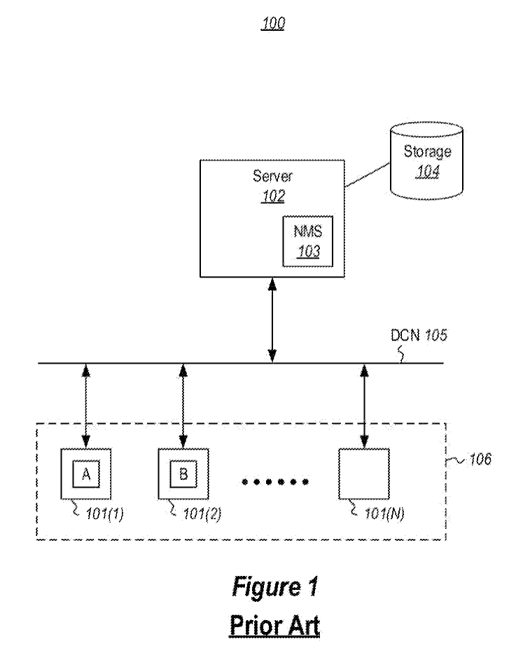

FIG. 3 illustrates a network management environment 300 in accordance with at least one embodiment described herein. The network management environment 300 includes a portion 310 that includes components that appear similar to the network management environment 100 of FIG. 1. In particular, the network elements sites 301(1), 301(2) through 301(N) (collectively referred to as the network element sites 301) may be similar to the network element sites 101 of FIG. 1. For instance, the network element sites 301 include one or more network elements that support a telecommunications network 306. The telecommunications network 306 may be, or may include, an optical network.

Furthermore, the server 302 may be similar to the server 102 of FIG. 1. The storage 304 may be similar to the storage 104 of FIG. 1, although the storage 304 need not be quite as large for reasons described below. The data communications network 305 may be similar to the data communications network 105 of FIG. 1. The server 302 also has a network management system 303, although the network management system 303 behaves differently than the network management system 103 of FIG. 1 as described below.

The network management environment 300 does, however, have numerous elements and aspects that are different than the conventional network management environment 100 of FIG. 1.

For instance, the network management environment 300 includes a security appliance 311 that enables communication between the network management system 303 (which is part of the closed and private data communications network 305) and network components outside of the closed and private data communications network 305 (such as the Internet). The security application 311 protects against ingress communication by protecting the network management system 303, the data communications network 305 and its associated telecommunications network 306 against intruders who would want to hack the network management system 303. On the other hand, the security appliance 311 allows the data from the storage 304 to be transferred over the channel 312 to an external system, such as a cloud computing environment 320. Hereinafter, the cloud computing environment 320 will be used as an example of the external system. However, the principles described herein apply regardless of the type of external system that is performing the network management described herein. The security appliance 311 may encrypt network element data transferred over the channel 312 to the cloud computing environment 320. Thus, the channel 312 may be an encrypted channel.

As previously mentioned, the convention network management system 103 has a store 104 to store network element data (e.g., performance monitoring data). In accordance with the principles described herein, at least part (and potentially all) of such network element data is instead transferred to the cloud computing environment 320. The cloud computing environment 320 has large storage volumes 321. Accordingly, the cloud computing environment 320 may store the high volumes of network element data generated by the network management system 303.

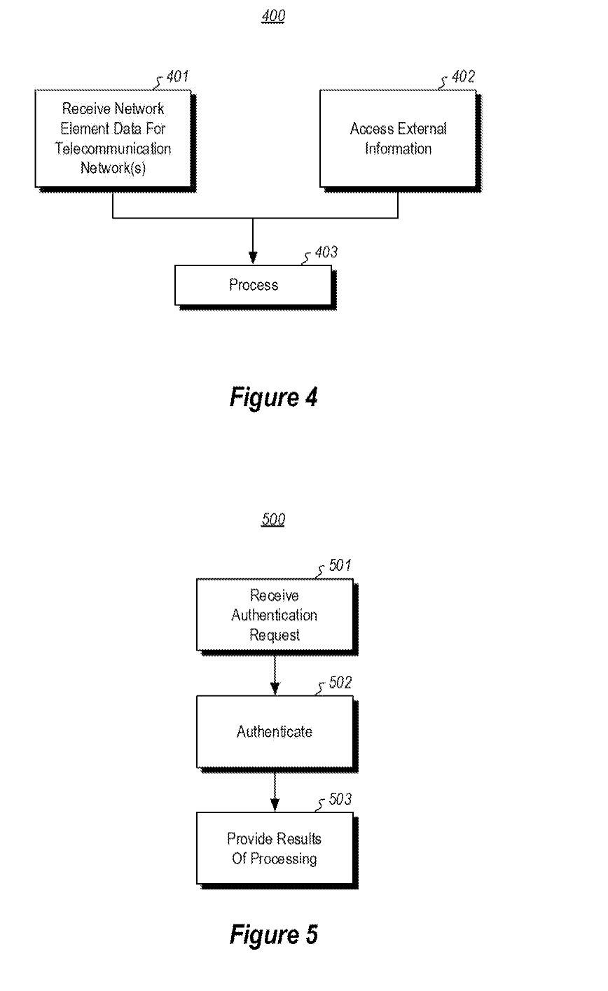

FIG. 4 illustrates a flowchart of a method 400 for processing network management data in an external system that is outside of a network management system. As an example, the method 400 may be performed by the cloud computing environment 320 of FIG. 3, although the method 400 may be performed by any external system that is external to the private data communication network 305.

As described above, the cloud computing environment receives network element data (act 401) from a network management system over an encrypted channel. For instance, the network element data gathered by the network management system 303 and potentially stored in the storage 304 may be provided through the security appliance 311 over the channel 312 and to communications module 323 of the cloud computing environment 312. The cloud computing system 320 then processes (act 403) at least some of the received network element data. Such processing may be performed by, for example, the processing modules 322 of the cloud computing environment 320. In this description and in the claims, processing of the received network element data may be as simple as storing such network element data in the storage volumes 321. However, as described further below, the processing might be more sophisticated and involve other input data as well.

In addition to network element data (such as performance monitoring data), the cloud computing environment 320 might also have access to a number of types of data that might be used in conjunction with the network element data for more sophisticated analysis. For instance, the cloud computing environment 320 may have accessed to manufacture data (as represented by arrow 331) for at least one network element having at least one reported parameter value within the received network element data. This manufacture data could correspond, for example, to the storage of a database of all the parameters of all the different modules constituting the different network elements of the telecommunications network at the time of their manufacture and could be used for comparison, tracking, preventative maintenance, and so forth.

Referring to FIG. 4, the method 400 also potentially includes receiving external information (act 402), an example of which being this manufacture data. The processing (act 403) of data could also involve processing this external information. Accordingly, the network management environment 300 could be a hybrid data environment that uses different data, albeit related to the telecommunications network 306 in different ways.

Other types of external information that may be received (in act 402) include environmental data such as weather data (see arrow 332 in FIG. 3) or temperature data. The external information might also include positional data such as geographic data (see arrow 333 in FIG. 3) or any other data (see arrow 334 in FIG. 3) that is not reported through a network management system corresponding to a telecommunications network, but might nonetheless be helpful in evaluating such information reported about a telecommunications network.

With reference to FIG. 3, optionally, in addition to receiving network element data from the network management system 303 corresponding to one telecommunications network, the cloud computing environment may receive (as represented by arrows 341, 342, and 343) network element data from other network management systems associated with respective other telecommunications networks as well. Accordingly, act 401 may be performed for each of multiple network management systems reporting network element data (e.g., performance monitoring data) for their respective telecommunications networks. Accordingly, the cloud computing environment 320 might process (act 403) network element data received (act 401) from multiple telecommunications networks perhaps in conjunction with the external information (act 402). As an example, the various telecommunications networks might have been manufactured by the same manufacturer for various customers, or operated by the same operator for various customers.

Returning to FIG. 4, given this large volume of data perhaps from different telecommunications networks, and perhaps involving external information, the processing (act 403) of that information might be quite sophisticated. Cloud computing environments may employ sophisticated numerical analysis tools which are capable of doing the analysis of large collection of data and also doing even prediction or trending of these data. The processing (act 403) might involve correlation, trending of anything and also some forecasting of the evolution of parameters for example.

Referring again to FIG. 3, the cloud computing environment can provide (as represented by arrows 351, 352 and 353) the results of the act of processing (act 403) to various authorized users, regardless of the types of computing systems or devices being used by those authorized users. FIG. 5 illustrates a flowchart of a method 500 for providing such resulting information to the authorized users. Upon receiving an authentication request (act 501) purported to be from an authorized administrator of the telecommunications network, the cloud computing environment 320 authenticates the authored administrator of that telecommunications network as being the issuer of the authentication request (act 502). In response to the authentication, the authorized administrator is permitted at least partial access to the results of the processing of network element data for that corresponding network (act 503).

Accordingly, the authorized administrators (e.g., operators, owners, and the like) of the various telecommunications networks can access the results of sophisticated processing on their telecommunication network data in a secure way. The authorized administers may use any device in order to do so such as computers (desktop or portable), smartphones or tablets, or any system or device. All these appliances would be connected to the cloud computing environment with a high degree of security (similar to what is done to get access to the network management system). These appliances would help the employees of the owner of the telecommunication network 306 to perform new tasks or improve their efficiency. As an example, image the vice president of operations of the owner of the telecommunications network 306 would like to see a very synthetic view of the network. Basically on the screen of his or her smartphone, he or she could see that the network is green (i.e., free from any alarm), could see the number of faults or alarms, could see the different status of these faults which is typically red, yellow or green, could see maybe a short description of the fault or alarm, and so forth. Such interfaces could be rendered by even the smallest of devices (such as a smartphone).

Furthermore, depending on capabilities of the appliance and on the profile of the users, there could be different modules of software used as an interface between the cloud computing environment 320 and these appliances to correspond to the target application. Accordingly, different users could get access to different information using different interfaces in accordance with the needs and desires of the user.

In summary, one or more network management systems may securely communicate network element data (e.g., performance monitoring data) for their respective telecommunications networks to an external system, such as a cloud computing environment. Such network element data may be processed potentially in conjunction with the network element data of other telecommunications networks and/or potentially in conjunction with external data, to thereby perform sophisticated analytics. Finally, the results of the processing may be provided in different ways to different users, even users who previously did not have access to the closed environment of conventional network management systems. This provides mobility and ubiquity for administrators, owners, providers, and associated agents thereof the telecommunications network. Such users do not need to be accessing a specific environment and they do not need to be in a specific place. Furthermore, such users have a much better view of the history of the network as this cloud environment provides access to the whole history of the network time wise and not only to the last hours or the last months. More generally, however, the principles described herein release network management system data to a lot more people who can use these data in their day-to-day work in very flexible fashion.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for processing network management data in an external system that is outside of a network management system, the method comprising:
an act of receiving network element data from a network management system over a channel into the external system, the network element data being parameter samples taken from one or more network elements that are within a telecommunications network that reports to the network management system; and
an act of processing at least some of the received network element data in the external system.

2. The method in accordance with claim 1, further comprising:
an act of receiving external information from external to the network management system; and
an act of processing at least some of the received external information, the act of processing at least some of the received external information involves at least some of the act of processing at least some of the received network element data.

3. The method in accordance with claim 2, the received external information comprising manufacturer data for at least one network element having at least one reported parameter value within the received network element data.

4. The method in accordance with claim 2, the received external information comprising environmental data.

5. The method in accordance with claim 2, the received external information comprising positional data.

6. The method in accordance with claim 1, at least some of the plurality of network elements being optical network elements of an optical network.

7. The method in accordance with claim 1, the external system being a cloud computing environment.

8. The method in accordance with claim 1, the act of processing at least some of the received network element data comprising an act of storing the at least some of the received network element data.

9. The method in accordance with claim 1, the network management system being a first network management system, the telecommunications network being a first telecommunications network, and network element data being first network element data, and the one or more network element data being a first set of one or more network elements, the method further comprising:
an act of receiving second network element data from a second network management system into the external system, the second network element data being parameter samples taken from a second set of one or more network elements that are within a second telecommunications network that is reports to the second network management system; and
an act of processing at least some of the received second network element data in the external system, wherein at least some of the act of processing at least some the received second network element data involves at least some of the act of processing at least some of the received first network element data.

10. The method in accordance with claim 1, further comprising:
an act of receiving an authentication request purported to be from an authorized administrator of the telecommunications network;
an act of authenticating the authorized administrator as the issuer of the authentication request; and
in response to the authentication request, permitting the authenticated authorized administrator access to at least one result from the act or processing at least some of the received network element data.

11. The method in accordance with claim 10, the act of processing comprising an act of using the at least some of the received network element data in order to identify trends in parameters measured within the received network element data.

12. A system comprising:
a communication module configured to receive network element data from at least one network management system over respective channels, each of the at least one network management system being associated with a corresponding telecommunications network that has at least one network element that reports parameter samples to the corresponding network management system, the network element data for each of the at least one network management system includes at least a processed version of the reported parameter samples reported to that corresponding network management system; and
a processing module configured to process of least some of the received network element data.

13. The system in accordance with claim 12, wherein for at least one of the channel for a corresponding network management system, the channel is encrypted and does not permit communications to go from the system to any network element within the associated telecommunications network.

14. The system in accordance with claim 12, the processing module further configured to process external information in association with at least some of the processing of at least some of the received network element data.

15. The system in accordance with claim 14, the external information comprising at least one of 1) manufacturer data for at least one of the network elements having at least one reported parameter value within the received network element data, 2) environmental data, and 3) positional data.

16. The system in accordance with claim 12, the system operating within a cloud computing environment.

17. The system in accordance with claim 12, further comprising:
an authentication module configured to authenticate authorized administrators for a particular telecommunications network, and permit access to at least one result of the act of processing at least some of the received network element data corresponding to the particular telecommunications network.

18. The system in accordance with claim 12, further comprising:
an encrypted channel corresponding to a respective network management system, the encrypted channel comprising a security appliance on a side of the encrypted channel proximate the respective network management system.

19. A computer program product comprising one or more computer-readable storage media having thereon computer-executable instructions that are structured such that, when executed by one or more processors of a computing system, cause the computing system to perform a method for processing network management data in an external system that is outside of a network management system, the method comprising:
an act of processing network element data received from a network management system, the network element data being parameter samples taken from one or more network elements that are within a telecommunications network that reports to the network management system.

20. The computer program product in accordance with claim 19, the network elements data being encrypted, the method further comprising:
an act of decrypting the network element data received from the network management system, the network element data received over an encrypted channel.
